(19) United States
(12) Patent Application Publication
(10) Pub. No.: US 2020/0294414 A1
(43) Pub. Date: Sep. 17, 2020

(54) DRIVING SIMULATOR

(71) Applicant: Ford Global Technologies, LLC, Dearborn, MI (US)

(72) Inventors: Abhishek SHARMA, Ann Arbor, MI (US); Pramita MITRA, West Bloomfield, MI (US); Yifan CHEN, Ann Arbor, MI (US)

(21) Appl. No.: 16/352,183

(22) Filed: Mar. 13, 2019

(51) Int. Cl. G09B 9/052; G06F 3/0484

(52) U.S. Cl. CPC G09B 9/052; H04L 67/02; G06F 3/04847

(57) ABSTRACT

A driving simulation platform includes one or more controllers of a driving simulator, programmed to perform a driving simulation for a pre-designed use case selected by a user via a web-based configuration interface, the driving simulation using road data imported from a cloud server; receive a signal to provide to an external device in communication with the driving simulation platform, the external device providing additional information in support of the simulation; and responsive to receiving a response from the external device, record the response as a simulation record.

### TECHNICAL FIELD

The present disclosure generally relates to a vehicle driving simulator. More specifically, the present disclosure relates to driving simulator integrated with a mobility computer-aided experience (CAE).

### BACKGROUND

Vehicle driving simulators are used to provide driving simulations for various scenarios. Professional drivers such as bus drivers may be trained using driving simulators before operating real vehicles on public roads. However, driving simulators may be unrealistic as the driving conditions may not accurately resemble real conditions. In addition, this simulation environment helps with digitally prototyping a mobility service to save time, cost and resources.

### SUMMARY

In one or more illustrative embodiment of the present disclosure, a driving simulation platform includes one or more controllers of a driving simulator, programmed to perform a driving simulation for a pre-designed use case selected by a user via a web-based configuration interface, the driving simulation using road data imported from a cloud server; receive a signal to provide to an external device in communication with the driving simulation platform, the external device providing additional information in support of the simulation; and responsive to receiving a response from the external device, record the response as a simulation record.

In one or more illustrative embodiment of the present disclosure, a method for a driving simulator includes responsive to receiving a user input via a web-based configuration application, importing a 3D city model and road network data into the driving simulator from a database; starting a driving simulation for a pre-designed use case selected by a user via the web-based configuration application; responsive to receiving a functionality input via the web-based configuration application, adjusting a functionality control for the simulation during a process of the simulation; and responsive to receiving a message from an external device, recording the message as a simulation record in a storage.

In one or more illustrative embodiment of the present disclosure, a non-transitory computer readable medium includes instructions, when executed by a driving simulator, cause the driving simulator to: responsive to receiving a user input via a web-based configuration application, import a 3D city model into the driving simulator from a cloud server; starting a driving simulation for a pre-designed use case selected by a user via the web-based configuration application; responsive to receiving a signal for an external device in communication with the driving simulator, send the signal to the external device; and responsive to receiving feedback from an external device responding the signal, recording the feedback as a simulation record in a storage.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a driving simulator system of one embodiment of the present disclosure;

FIG. 2 illustrates an example architecture diagram of a mobility CAE platform of one embodiment of the present disclosure;

FIG. 3 illustrates an example user interface diagram of the mobility CAE platform of one embodiment of the present disclosure;

FIG. 4 illustrates an example preview/modify interface diagram of the mobility CAE platform of one embodiment of the present disclosure;

FIG. 5 illustrates an example customization interface diagram of the mobility CAE platform of one embodiment of the present disclosure;

FIG. 6 illustrates an example schematic diagram of the mobility CAE platform of one embodiment of the present disclosure; and

FIG. 7 illustrates an example flow diagram for a process of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle driving simulator. More specifically, the present disclosure proposes a driving simulator integrated with CAE based on internet-of-things (IoT) platform.

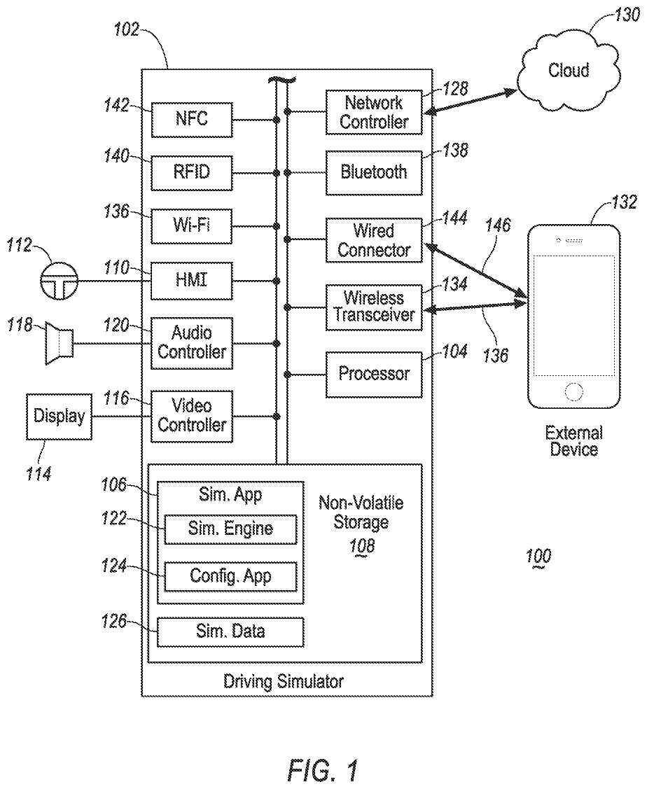

Referring to FIG. 1, an example block topology of a driving simulator system 100 of one embodiment of the present disclosure is illustrated. A driving simulator 102 may include one or more processors 104 configured to perform instructions, commands, and other routines in support of the processes described herein. For instance, the driving simulator 102 may be configured to execute instructions of simulator applications 106 to provide features such as driving simulation and communication. Such instructions and other data may be maintained in a non-volatile manner using a variety of types of computer-readable medium 108. The computer-readable medium 108 (also referred to as a processor-readable medium or storage) includes any non-transitory medium (e.g. tangible medium) that participates in providing instructions or other data that may be read by the processor 104 of the driving simulator 102. Computer-executable instructions may be compiled or interpreted from computer programs created using a variety of programming languages and/or technologies, including, without limitation, and either alone or in combination, Java, C, C++, Objective C, Fortran, Pascal, Java Script, Python, Perl, and PL/SQL.

The driving simulator 102 may be provided with various features allowing users to interface with the driving simulator 102. For instance, the driving simulator 102 may receive input from human-machine interface (HMI) controls 110 configured to provide for user interaction with the driving simulator 102. As an example, the driving simulator 102 may interface with an input/output (I/O) controller 112 or other controllers via the HMI controls 110. The I/O controller 112 may include a steering wheel, a gear shifter, pedals or the like configured to provide the user with driving inputs to simulate a vehicle driving environment.

The driving simulator 102 may also send signals to or otherwise communicate with one or more displays 114 configured to provide visual output to a user by way of a video controller 116. In some cases, the display 114 may be provided with touch screen features configured to receive user touch input via the video controller 116, while in other cases the display 114 may be a display only, without touch input capabilities. The display 114 may be a liquid-crystal display (LCD), active-matric organic light-emitting diode display (AMOLED), a head up display (HUD), a projector, virtual reality (VR) glasses, augmented reality (AR) glasses, or mixed reality (MR) glasses as a few non-limiting examples. The driving simulator 102 may also drive or otherwise communicate with one or more speakers 118 configured to provide audio output to the user by way of an audio controller 120.

The simulator applications 106 may include various applications or software configured to perform various features. For instance, the simulator applications 106 may include a simulation engine 122 configured generate driving simulations for the user to simulate driving environment include street, city, signals, traffics or the like. The simulator applications 106 may further include a configuration application 124 configured to provide an interface to allow the user to configure and adjust parameters for driving simulations. The configuration application 124 may be configured to support a web-based input from a web (to be introduced below). Digital data used to perform simulations may be stored in the storage 108 as a part of simulator data 126. For instance, the simulator data 126 may include data models simulating streets, traffics, and different vehicles, to provide a variety of simulation options. The simulator data 126 may further include user profiles associate with one or more users configure to provide driving records of the users.

The driving simulator 102 may be further provided with a network controller 128 configured to communicate with a cloud 130 e.g. using a modem (not shown). The term cloud is used as a general term in the present disclosure and may include any computing network involving computers, servers, controllers or the like configured to perform data processing and storage functions and facilitate communication between various parties. The driving simulator 102 may be configured download and upload simulator applications 106 and simulation data 126 from and to the cloud.

The driving simulator 102 may be further configured to wirelessly communicate with an external device 132 via a wireless transceiver 134 through a wireless connection 136. The external device 132 may be any of various types of portable computing device, such as cellular phones, tablet computers, wearable devices, smart watches, laptop computers, vehicle scan tool, or other device capable of communication with the driving simulator 102. A wireless transceiver 134 may be in communication with a Wi-Fi controller 136, a Bluetooth controller 138, a radio-frequency identification (RFID) controller 140, a near-field communication (NFC) controller 142, and other controllers such as a Zigbee transceiver, an IrDA transceiver (not shown), and configured to communicate with a compatible wireless transceiver (not shown) of the external device 132. Additionally or alternatively, the driving simulator 102 may be configured to communicate with the external device via a wired connector 144 through a cable 146. The wired connector may be configured to support various connection protocols including universal serial bus (USB), Ethernet, or on-board diagnostics 2 (OBD-II) as a few non-limiting examples.

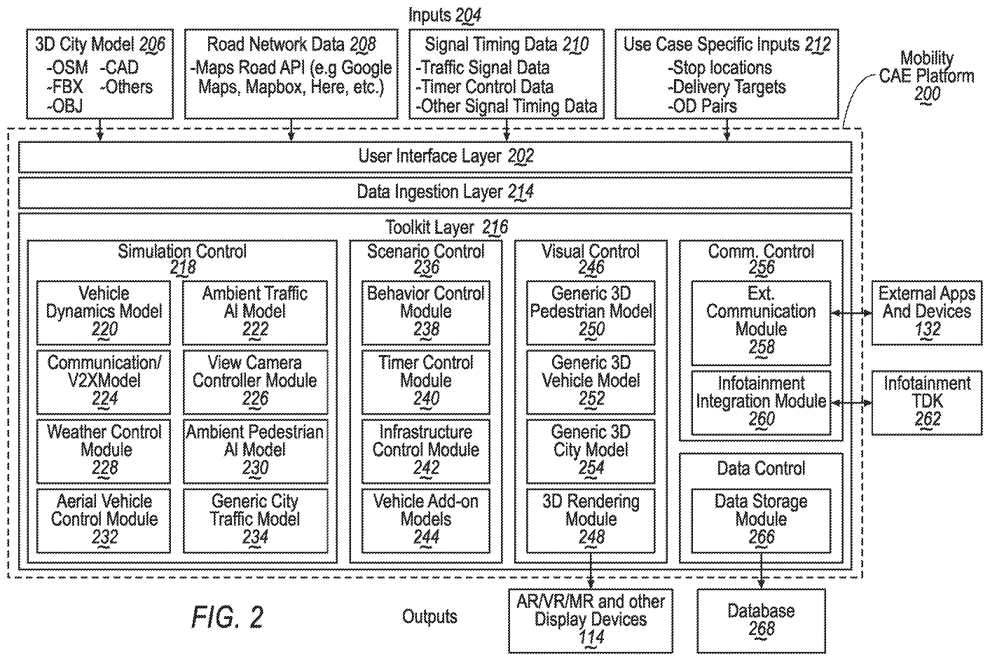

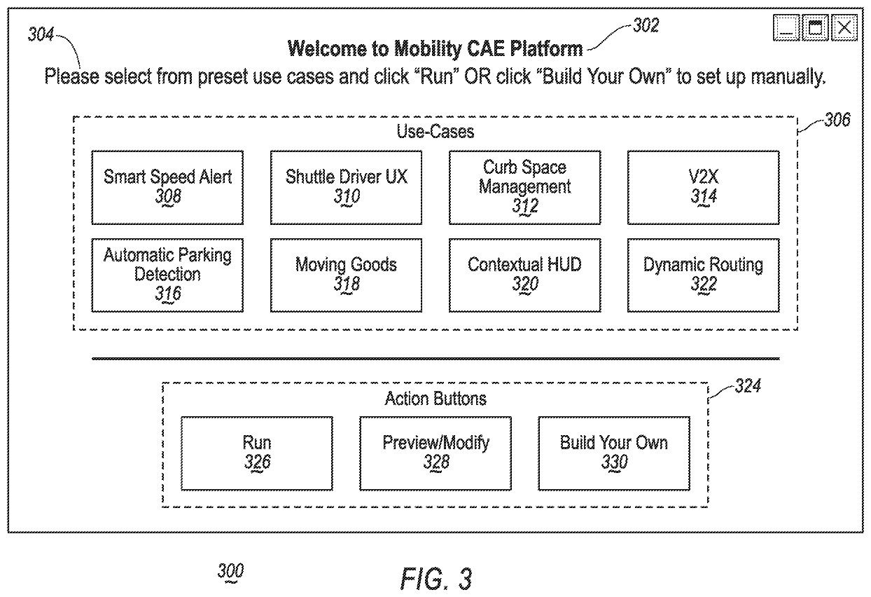

Referring to FIG. 2, an example architecture diagram of a mobility CAE platform 200 of one embodiment of the present disclosure is illustrated. With continuing reference to FIG. 1, the mobility CAE platform 200 may be implemented via a single driving simulator 102. Alternatively, the mobility CAE platform 200 may be implemented by a combination of the driving simulator 102 with other devices such as servers (not shown) with communication and processing capabilities. The mobility CAE platform 200 may have a user interface (UI) layer 202 configured to load various inputs 204 and provide integration with new use-cases. A use-case may be used resemble a specific driving scenario for training purposes. For instance, one use-case may include an emergency response to simulate driving an emergency vehicle. Details of the use-cases is discussed in details below with reference to FIG. 3. The inputs 204 may be downloaded by the driving simulator 102 from the cloud 130. The inputs 204 may include various data/models used by the driving simulator 102 to perform simulations. For instance, the inputs 204 may include a three-dimensional (3D) city model 206 configured to simulate a city environment presented in 3D. The city environment may resemble a real city (e.g. New York) to provide a more realistic simulation. Alternatively, the 3D city model 206 may include hypothetical cities for specific purposes. The 3D city model 206 may include various forms/formats of data models. As a few non-limiting examples, the 3D city model 206 may include OpenStreetMap (OSM), filmbox (FBX), object (OBJ), and/or computer-aided design (CAD) models, supported by the driving simulator 102.

The inputs 204 may further include road network data 208 configured to provide road network data to simulate roads. For instance, the road network data may include various map and road application programming interfaces (APIs) such as Google Maps®, Mapbox®, Here®, or the like associated with one or more third parties, to provide the user with a more realistic road simulation environment. The inputs 204 may further include signal timing data 210 configured to provide street signals data for simulation purposes. Some cities use adaptive or coordinated traffic signal schemes to improve traffic conditions. The signal timing data 210 may include traffic signal data, timer control data, and/or other signal time data to provide more accurate simulations to various traffic schemes. The inputs 204 may further include a use-case specific inputs 212, such as stop locations, delivery targets, and/or origin-destination (OD) pairs to provide specific inputs for each simulation use case.

Since the UI layer 202 may be configured to support inputs 204 in various formats/forms, the mobility CAE platform 200 may further include a data ingestion layer 214 configured to convert the inputs 204 received via the UI layer 202 into a universal standardized format. For instance, the 3D city model 206 as discussed above may be from various sources and include various models (e.g. OSM and CAD). The models in those formats may not be immediately usable by the driving simulator 102. The data ingestion layer 214 may be configured to process the 3D city models 206 and convert the models into a standardized format/form which is supported throughout the mobility CAE platform 200.

The mobility CAE platform 200 may further include a toolkit layer 216 configured to process the data/models having been converted via the toolkit layer 216 to provide the user with driving simulations. The toolkit layer 216 may include multiple groups of modules for simulation. For instance, the toolkit layer 216 may include a simulation control group 218 configured to operate vehicle driving simulation controls of the driving simulator 102. The simulation control group 218 may include a vehicle dynamics model 220 configured to define performance and capabilities of a subject vehicle using various parameters. The vehicle dynamics model 220 may define various types of vehicle for simulations to provide users with different needs. For instance, the vehicle dynamics model 220 may include vehicle models for passenger vehicles, sport vehicles, racing vehicles, sport utility vehicles (SUVs), pickup trucks, semi-trucks, emergency vehicles (e.g. ambulance, police vehicle, or fire engines), or the like configured to allow the user to simulate driving experience with those vehicles. Although driving simulations may be performed as the user driving alone without any traffic, a more realistic simulation would include ambient vehicles operated by computer. The simulation control group 218 may further include an ambient traffic artificial intelligent (AI) model 218 configured to define the driving behavior of ambient vehicles. The ambient traffic AI model 218 may include parameters to simulate various ambient traffic driving behavior with multiple levels of aggressiveness, traffic density or the like.

The simulation control group 218 may further include a communication/vehicle-to-everything (V2X) model 224 configured to simulate intra-simulation communication and V2X interactions. For instance, the communication/V2X model 224 may allow a user in a simulation for an emergency vehicle to communicate with a virtual control center and change the traffic signals to simulate emergency response situation. The simulation control group 218 may further include a view camera controller module 226 configured to enable controls for a subject camera. The view camera controller module 226 may be used to move the camera to different positions to simulate sitting in different types of vehicles (e.g. cars, trucks). The simulation control group 218 may further include a weather control module 228 configured to control weather and time of the day for simulations. The simulation control group 218 may further include an ambient pedestrian AI model 230 configured to define the behavior of pedestrians for simulations. Similar to the operations of the ambient traffic AI model 222, the ambient pedestrian AI model may be configured to control the number of pedestrians, speed of movement, different levels of aggressiveness (e.g. jaywalking) to provide a more realistic simulation environment. The simulation control group 218 may further include an aerial vehicle control module 232 configured to support modelling and control of aerial vehicles (e.g. drones). For instance, the driving simulator 102 may be configured to simulate specific use-cases related to aerial vehicle-based goods delivery or other unmanned aerial vehicle (UAV) use-cases through the aerial vehicle control module 232. The simulation control group 218 may further include a generic city traffic model 234 configured to define traffic pattern/flow in a generic city where road network data is not available.

The toolkit layer 216 may further include a scenario control group 236 having multiple entries configured to control simulation scenarios of the driving simulator 102. The scenario control group 236 may include a behavior control module 238 configured to provide a scenario-specific behavior control for a target. For instance, a target may include a pedestrian crossing the road in from of the simulating vehicle in which case the user is required to take actions to avoid an accident. The scenario control group 236 may further include a timer control module 240 configured to provide for one or more timers to keep a check of virtual time or to create scenarios, as some scenarios may have time requirements (e.g. a shuttle driving simulation). The scenario control group 236 may further include an infrastructure control module 242 configured to allow controls over various infrastructures such as traffic lights, railway signals, or the like. The scenario control group 236 may further include one or more vehicle add-on models 244 configured to put add-on items on a simulating vehicle such as a snow plow, a trailer or the like, by modifying parameters of the vehicle dynamics model 220.

The toolkit layer 216 may further include a visual control group 246, configured to provide visual images to the user via the display 114 by way of the video controller 116. The visual control group 246 may include a 3D rendering module 248 configured to render 3D graphics for the Display 114 via the video controller 116. The visual control group 246 may include various generic models. For instance, the visual control group 246 may include a generic 3D Pedestrian model 250 configured to provide a generic or default visual model for pedestrians in case that the user does not provide a specific visual model for pedestrian. The visual control group 246 may further include a generic 3D vehicle model 252 configured to provide a generic 3D model for vehicles in case that the user does not provide a specific visual model for vehicles. The visual control 246 may further include a generic 3D city model 254 configured to provide a generic 3D model of the city utilized for simulations in case that the user does not provide a 3D model for the city of preference.

The toolkit layer 216 may further include a communication control group 256 configured to control the communication between the driving simulator 102 and external devices or services. The communication control group 256 may include an external communication module 258 configured to enable bi-directional communications with the external device 132 via applications through the cable 146 and/or the wireless connection 136. In addition to the external device 132, the driving simulator 102 may be connected to a vehicle infotainment system 262 to provide a more realistic driving simulation environment. For instance, the infotainment system 262 may include the SYNC system manufactured by The Ford Motor Company of Dearborn, Michigan. Therefore, the communication control group 256 may further include an infotainment integration module 260 configured to enable communication between the driving simulator 102 and an infotainment system 262 through various types of wired or wireless connections.

The toolkit layer 216 may further include a data control module 264 which has a data storage module 266 configured to load and store simulation data including data analytics and simulation results from and to a database 268. The database 268 may be implemented locally using a server managed via software such as SQLite in communication with the driving simulator 102. Alternatively, the database 268 may be implemented in the storage 108 of the driving simulator 102. Alternatively, the database 268 may be implemented on the cloud 130 in communication with the driving simulator 102 via the network controller 128.

Referring to FIG. 3, an example diagram for a user interface 300 of the mobility CAE platform 200 of one embodiment of the present disclosure is illustrated. The user interface 300 may be a web-based interface implemented on a computer communicating with the driving simulator 102 and configured to facilitate set up of a simulation for the user. The user interface 300 may include a title or welcome message 302 displayed on the top of the screen followed by an instruction line 304. The user interface 300 may be configured to allow the user to choose from a variety of pre-designed use-case options 306. For instance, the use-cases 306 may include a smart speed alert option 308, a shuttle driver user experience (UX) option 310, a curb space management option 312, a V2X option 314, an automatic parking detection option 316, a moving goods option 318, a contextual head up display (HUD) option 320, and a dynamic routing option 322. The user interface 300 may be configured to allow to choose one or more use-cases 306 by clicking on the option via an icon operated by a mouse or directly touching the option on a touchscreen (if provided).

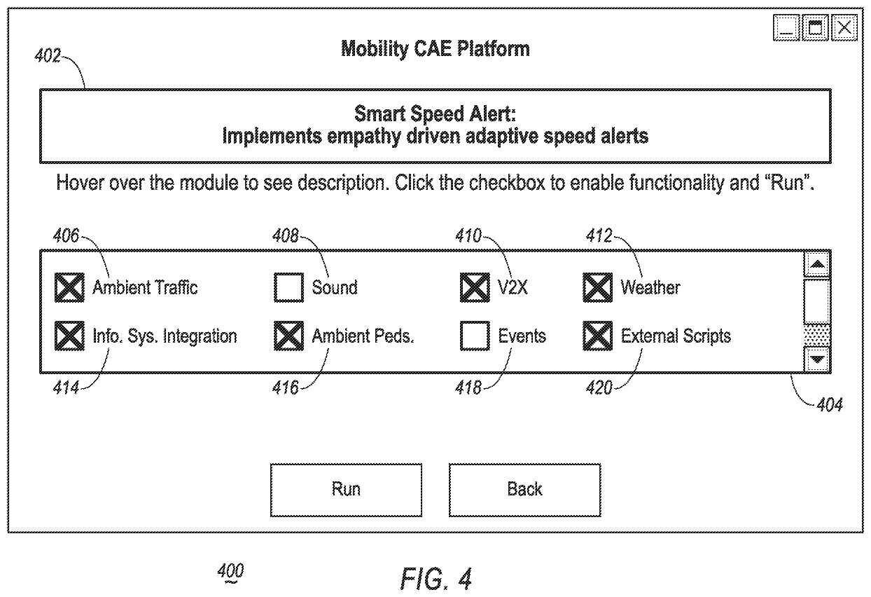

The user interface 300 may further provide the user with one or more option buttons 324 to trigger various actions. As illustrated in FIG. 3, there are totally three action buttons 324. A Run action button 326 may trigger the driving simulator 102 to launch the selected pre-designed simulation selected from the use-cases 306 and start the simulation. The Preview/Modify button 328 may allow the user to enter a preview/modify interface as illustrated in FIG. 4 to enable and disable certain features/functionalities of pre-designed simulations. Referring to FIG. 4, the preview/modify interface 400 for the smart speed alert use-case of one embodiment of the present disclosure is illustrated. With continuing reference to FIG. 3, a use-case label 402 indicating the specific use-case (i.e. the smart speed alert 308 in the present example) may be displayed to remind the user of the current use-case. In addition, the preview/modify interface 400 may further include functionality cluster 404 configured to offer the user with options to enable and disable multiple functionalities. For instance, the functionality cluster 404 for the smart speed alert 308 may include options to enable/disable the following functionalities: ambient traffic 406, sound 408, V2X 410, weather 412, infotainment integration 414, ambient pedestrians 416, events 418, and external scripts 420, as a few non-limiting examples. Available functionalities associated with different use-cases 406 may differ. The user may enable and disable each available functionality by checking and unchecking the check box for each option.

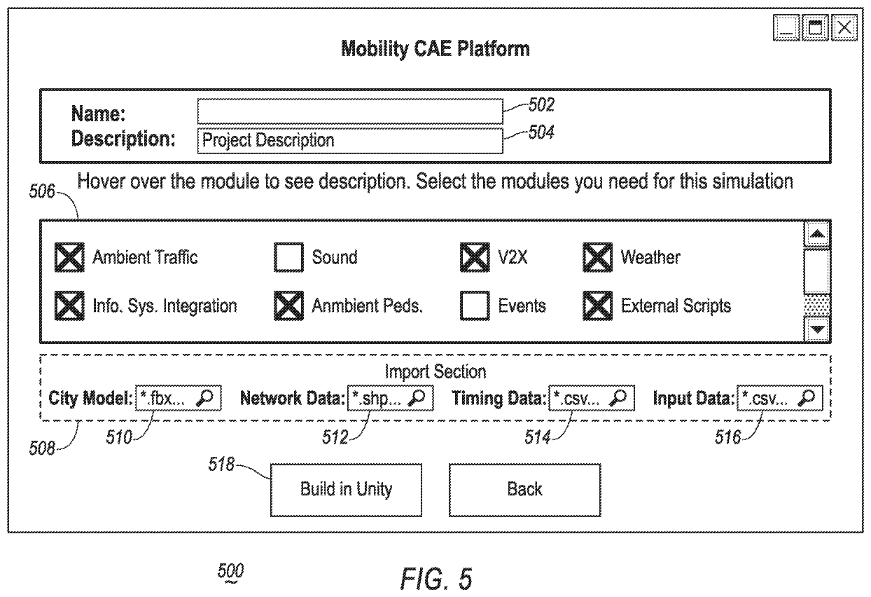

As illustrated in FIG. 3, the user interface 300 may further include a Build Your Own button 330 configured to give the user the option to build his/her own customized simulations. By clicking on the Build Your Own button 330, the user interface 300 may switch to a customization interface 500 as illustrated with reference to FIG. 5. As illustrated in FIG. 5, the customization interface 500 may be configured to invite the use to input a name 502 and a brief description 504 for the use-case to be built. Additionally, a functionality cluster 506 may be provided to allow the user to enable/disable various functionalities similar to the embodiment already described above with reference to FIG. 4. The customization interface 500 may further include an import section 508 configured to provide an interface to allow the user to import models or data files to build the simulation. As a few non-limiting examples, the import section 508 may be configured to allow the user to import a city model 510, network data 512, timing data 514, and input data 516. The import section 508 may be configured to allow the use to import data from a local storage (e.g. the storage 108 or a local server), or from the cloud 130. Upon finishing the customization and importation, the user may click on the Build in Unity button 518 to proceed to build the customized simulation.

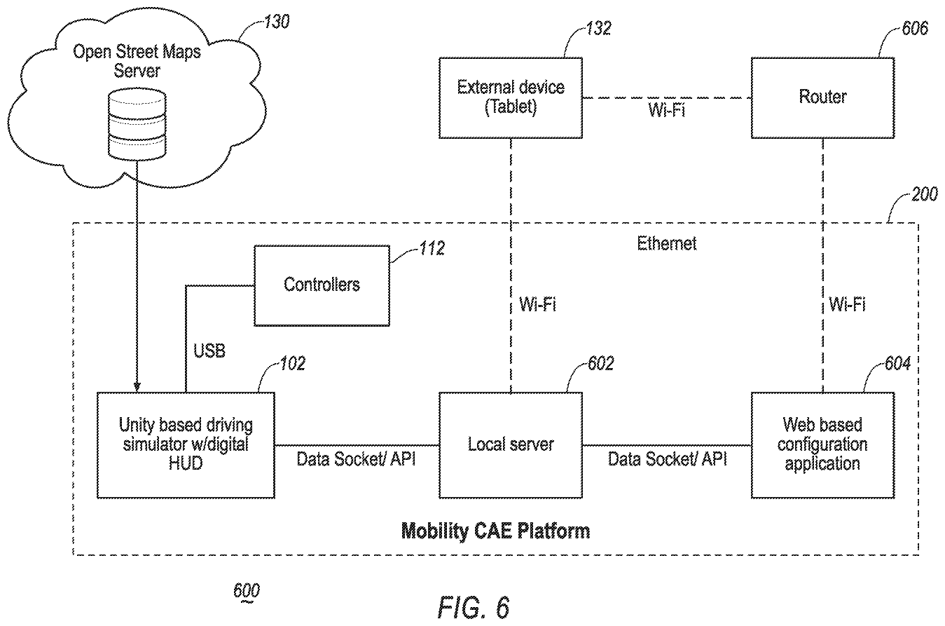

Referring to FIG. 6, a schematic diagram 600 of the mobility CAE platform 200 is illustrated. The driving simulator 102 may be provided with a digital HUD and configured to communicate with an open street maps server 130 to download street data therefrom. The driving simulator 102 may be connected with I/O controllers 112 such as a steering wheel and pedals via a USB connection to provide driving inputs. The driving simulator 102 may be further configured to communicate with a local server 602 through an application programming interface (API). The local server 602 may be connected to one or more driving simulators 102 and configured to manage and control the simulations of the driving simulators 102. For instance, the local server 602 may be provided with a database (not shown) configured to store simulation data of each driving simulator 102 and/or each user. The local server 602 may be configured to support a web-based configuration application 604 to provide an interface (e.g. the user interface 300) enabling the configuration of the simulations. The local server 602 may be configured to allow a manager to dynamically modify settings of a simulation via the web-based configuration application 604 while the simulation is being performed via the driving simulator 102 to provide the user with a more realistic experience. For instance, the manager may change parameters such as weather conditions, traffic conditions, accidents via the web-based configuration application to train the user how to respond to unexpected situations.

In reality, many drivers may use an external device (e.g. a smart phone, or a tablet) to perform various operations such as communication and navigation, while operating the vehicle. To accommodate that particular training need, the mobility CAE platform 200 may be configured to support a connection to the external device 132 via a Wi-Fi connection. Additionally, the manager controlling the simulation may access the external device via the web-based configuration application through a connection (e.g. a router 606) to provide communication and instructions. For instance, in case that the user is simulating a shuttle driver UX 310, the manager may send new pickup and drop off locations to the user via the external device using the web-based configuration application 604 to simulator dynamic real-life situations.

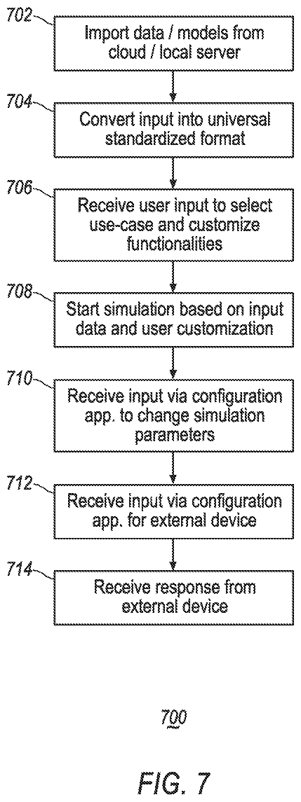

Referring to FIG. 7, an example flow diagram for a process 700 of one embodiment of the present disclosure is illustrated. At operation 702, the mobility CAE platform 200 imports data and models 204 from the cloud 130 or the local server 602 responsive to user input via the web-based configuration application 604. As discussed with reference to FIG. 2, the inputs 204 may include a 3D city model 206, road network data 208, signal timing data 210 and/or use-case specific inputs. Responsive to receiving the data import, at operation 704, the mobility CAE platform 200 coverts the inputs 204 into a universal standardized format recognizable throughout the platform. At operation 706, the mobility CAE platform 200 receives user input to select a use-case to simulate and to enable/disable functionalities via the configuration application 604.

At operation 708, the mobility CAE platform 200 starts the simulation based on the imported inputs 204 and user customization. Depending on the specific use-case functionality settings, different control modules within the toolkit layer 216 of the mobility CAE platform 200 may be enabled or disabled. Taking the shuttle driver UX 310 for instance, the following modules/models of the toolkit layer 216 may be enabled by default: the vehicle dynamics model 220, the ambient traffic AI model 222, the view camera controller module 226, the weather control module 228, the timer control module 240, the infrastructure control module 242, the 3D rendering module 248, the generic 3D vehicle model 252, the external communication module 258 and the data storage module 266. As discussed above, the mobility CAE platform 200 may be configured to allow a user or manager to modify the enabling/disabling of the toolkit layer controls to adjust the simulation. At operation 710, the mobility CAE platform 200 receives an input to change simulation parameters via the web-based configuration application 604. For instance, responsive to detecting the weather functionality 412 is unchecked, the mobility CAE platform 200 may disable the weather control module 228 to reduce the difficulty of the simulation as needed.

At operation 712, the mobility CAE platform 200 receives an input via the web-based configuration application 604 for the external device 132 connected via the external communication module 258. For instance, while simulating a shuttle driver UX 310 use-case, the mobility CAE platform 200 may dynamically receive updates for new pickup and drop off locations for new passengers via the web-based configuration application 604. Such new updates are sent to the external device 132 to inform the user performing the simulation. The user may drive the simulating vehicle based on the instructions from the external device 132. After each successful pickup and/or drop off, the user may provide a feedback/response via the external device. At operation 714, the mobility CAE platform 200 receives the user response from the external device and record the response as a simulation data. Continuing to use the shuttle driver UX 310 use-case for example, the mobility CAE platform 200 may record the timing of each user response indicative of a successful pickup or drop off to monitor the performance of the user.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A driving simulation platform, comprising:
one or more controllers of a driving simulator, programmed to
perform a driving simulation for a pre-designed use case selected by a user via a web-based configuration interface, the driving simulation using road data imported from a cloud server;
receive a signal to provide to an external device in communication with the driving simulation platform, the external device providing additional information in support of the simulation; and
responsive to receiving a response from the external device, record the response as a simulation record.

2. The driving simulation platform of claim 1, wherein the one or more controllers are further programmed to:
responsive to receiving a functionality input via the web-based configuration interface, adjust a functionality control for the simulation.

3. The driving simulation platform of claim 2, wherein the one or more controllers are further programmed to:
perform adjustment to the functionality control while the simulation is being performed.

4. The driving simulation platform of claim 2, wherein the one or more controllers are further programmed to:
adjust a simulation control including at least one of: a vehicle dynamics model, an ambient traffic artificial intelligence (AI) model, a vehicle-to-everything (V2X) model, a view camera controller module, a weather control module, an ambient pedestrian AI model, an aerial vehicle control module, or a generic city traffic model.

5. The driving simulation platform of claim 2, wherein the one or more controllers are further programmed to:
adjust a scenario control including at least one of: a behavior control module, a timer control module, an infrastructure control module, or a vehicle add-on model.

6. The driving simulation platform of claim 2, wherein the one or more controllers are further programmed to:
adjust a visual control including at least one of: a three-dimensional (3D) rendering module, a generic 3D pedestrian model, a generic 3D vehicle model, or a generic 3D city model.

7. The driving simulation platform of claim 2, wherein the one or more controllers are further programmed to:
adjust a communication control including: an external communication module configured to communicate with the external device, or an infotainment integration module.

8. The driving simulation platform of claim 1, wherein the one or more controllers are further programmed to:
responsive to receiving a user input via the web-based configuration interface, import at least one of following data into the driving simulation platform from the cloud server: 3D city model, signal timing data, or use case specific input.

9. The driving simulation platform of claim 1, wherein the one or more controllers are further programmed to:
communicate with an infotainment device via an infotainment integration module.

10. A method for a driving simulator, comprising:
responsive to receiving a user input via a web-based configuration application, importing a 3D city model and road network data into the driving simulator from a database;
starting a driving simulation for a pre-designed use case selected by a user via the web-based configuration application;
responsive to receiving a functionality input via the web-based configuration application, adjusting a functionality control for the simulation during a process of the simulation; and
responsive to receiving a message from an external device, recording the message as a simulation record in a storage.

11. The method of claim 10, further comprising:
adjusting a simulation control by enabling or disabling at least one of: a vehicle dynamics model, an ambient traffic AI model, a V2X model, a view camera controller module, a weather control module, an ambient pedestrian AI model, an aerial vehicle control module, or a generic city traffic model.

12. The method of claim 10, further comprising:
adjusting a scenario control by enabling or disabling at least one of: a behavior control module, a timer control module, an infrastructure control module, or a vehicle add-on model.

13. The method of claim 10, further comprising:
adjusting a visual control by enabling or disabling at least one of: a three-dimensional (3D) rendering module, a generic 3D pedestrian model, a generic 3D vehicle model, or a generic 3D city model.

14. The method of claim 10, further comprising:
adjust a communication control by enabling or disabling: an external communication module configured to communicate with the external device, or an infotainment integration module.

15. The method of claim 10, wherein the database is located remotely at a cloud server connected to the driving simulator via a communications network.

16. The method of claim 10, further comprising:
responsive to receiving the user input via a web-based configuration application, importing signal timing data and use case specific inputs into the driving simulator from the database.

17. A non-transitory computer readable medium comprising instructions, when executed by a driving simulator, cause the driving simulator to:
responsive to receiving a user input via a web-based configuration application, import a 3D city model into the driving simulator from a cloud server;
starting a driving simulation for a pre-designed use case selected by a user via the web-based configuration application;
responsive to receiving a signal for an external device in communication with the driving simulator, send the signal to the external device; and
responsive to receiving feedback from an external device responding the signal, recording the feedback as a simulation record in a storage.

18. The non-transitory computer readable medium of claim 17, further comprising instructions, when executed by a driving simulator, cause the driving simulator to:
responsive to receiving a functionality input via the web-based configuration application, adjusting a functionality control for the simulation during a process of the simulation.

19. The non-transitory computer readable medium of claim 17, further comprising instructions, when executed by a driving simulator, cause the driving simulator to:
responsive to receiving the user input via a web-based configuration application, importing road network data, signal timing data, and use case specific inputs into the driving simulator from the cloud server.

20. The non-transitory computer readable medium of claim 17, further comprising instructions, when executed by a driving simulator, cause the driving simulator to:
communicate with an infotainment device via an infotainment integration module through a wired connection.
